(19) United States
(12) Patent Application Publication
(10) Pub. No.: US 2011/0099271 A1
(43) Pub. Date: Apr. 28, 2011

(54) SYSTEM AND METHOD FOR ENFORCING RFID EVENT MANAGEMENT POLICY

(76) Inventors: Joo Sang PARK, Daejeon (KR); Hyo Chan Bang, Daejeon (KR); Hee Sook Mo, Daejeon (KR); Jee Sook Eun, Daejeon (KR); Se Won Oh, Daejeon (KR); Jae Gak Hwang, Daejeon (KR); Jong Suk Chae, Daejeon (KR); Kwang Hoon Kim, Gyeonggi-do (KR); Ji Hye Song, Seoul (KR); Sun Jin Kim, Daejeon (KR); Hyung Jin Ahn, Seoul (KR)

(21) Appl. No.: 12/790,271

(22) Filed: May 28, 2010

(30) Foreign Application Priority Data
Oct. 22, 2009 (KR) 10-2009-0100681
May 26, 2010 (KR) 10-2010-0048917

(51) Int. Cl. G06F 15/173

(52) U.S. Cl. 709/224; 709/223

(57) ABSTRACT

Provided are a system and method for enforcing a radio frequency identification (RFID) event management policy. The system includes a policy definer for defining an RFID event management policy to be used by a client to manage an apparatus on the basis of an RFID event, a policy storage for storing the RFID event management policy, a policy determiner for selecting the RFID event management policy stored in the policy storage using a profile of the client included in an RFID event management policy request when the RFID event management policy request is received from the client, and a policy enforcer converting the selected RFID event management policy according to a standard executable by the client.

### CROSS-REFERENCE TO RELATED APPLICATION

This application claims priority to and the benefit of Korean Patent Application Nos. 10-2009-0100681 filed Oct. 22, 2009 and 10-2010-0048917 filed May 26, 2010, the disclosure of which is incorporated herein by reference in its entirety.

### BACKGROUND

1. Field of the Invention

The present invention relates to a system and method for enforcing a radio frequency identification (RFID) event management policy, and more particularly to an RFID event management policy enforcement system and method that define and distribute an RFID event management policy.

2. Discussion of Related Art

A typical RFID event management framework includes an RFID event processing system that refines and processes an event satisfying a specific situation among a large number of raw events collected from multiple different RF readers, an event capture application that supports a refinement result event to interoperate with a business logic, and a business application, such as enterprise resource planning (ERP), customer relation management (CRM), supply chain management (SCM), or a transportation management system (TMS), that actually processes the business logic.

A conventional application service providing process based on an RFID event management framework is as follows: First, an RFID event manager transfers tag data to the business application to provide service required by users, defines an RFD event management standard specification in which a specific situation and refinement processing condition are recorded, and then registers the standard specification with management target event processing systems in a domain. After this, an RFID event processing system collects, refines and processes raw events generated from multiple RF readers on the basis of content defined in the RFID event management standard specification by the manager, and transmits the processed raw events to the event capture application. Then, the business application performs the business logic to be provided to users using the tag data transferred from the event capture application.

However, conventional RFID event management systems have four problems described below.

First, in terms of usefulness, a definition of an RFID event management standard specification is complicated. In other words, conventional RFID event management systems cannot provide a definition interface that managers having little technical knowledge can simply and conveniently use. Second, in terms of transparency, various RFID event management standards differ from each other. In other words, RFID event processing system managers perform RFID event management standard specification definition and distribution dependent on the respective management system-based standards. Third, the problem of efficiency occurs due to a passive RFID event management method that involves frequent intervention from a user. In other words, RFID event processing system managers must intervene in multiple actions required for RFID event management satisfying a specific situational condition. Fourth, the problem of flexibility in an RFID event management range occurs. In other words, conventional RFID event processing systems do not take interoperation with another RFID system into consideration.

### SUMMARY OF THE INVENTION

The present invention is directed to a system and method for enforcing a radio frequency identification (RFID) event management policy from the viewpoint of a user using the concept of policy.

The present invention is also directed to an RFID event management policy enforcement system and method capable of managing RFID application processing systems of the same type or different types.

The present invention is also directed to defining an RFID event management policy appropriate for a user's RFID application system as a policy and dynamically determining and distributing the policy to minimize intervention from a manager.

One aspect of the present invention provides a system for enforcing an RFID event management policy including: a policy definer for defining an RFID event management policy to be used by a client to manage an apparatus on the basis of an RFID event; a policy storage for storing the RFID event management policy; a policy determiner for selecting the RFID event management policy stored in the policy storage using a profile of the client included in an RFID event management policy request when the RFID event management policy request is received from the client; and a policy enforcer converting the selected RFID event management policy according to a standard executable by the client.

The policy definer may include: a policy setting manager for receiving information for configuring the RFID event management policy from the policy storage, or newly generating the information; and a policy modeler for defining the RFID event management policy using the information for configuring the RFID event management policy.

The policy setting manager may include: a policy information unit for receiving name information of the RFID event management policy from the policy storage, or newly generating the name information; an operation information unit for receiving operation information for the client to drive the apparatus according to the RFID event management policy from the policy storage, or newly generating the operation information; an area information unit for receiving area information, which is information on an area of the apparatus to which the client applies the RFID event management policy, from the policy storage, or newly generating the area information; a target information unit for receiving target information, which is information on the apparatus to which the client applies the RFID event management policy, from the policy storage, or newly generating the target information; and a result report information unit for receiving result report information, which is information on an external terminal receiving a result report resulting from application of the RFID event management policy, from the policy storage, or newly generating the result report information.

The policy modeler may include: an event policy condition definer for defining a condition on which the RFID event management policy works using the information for configuring the RFID event management policy; and an event policy action definer for defining the RFID event management policy including operation of the client performed when the condition is satisfied.

The system may further include a policy event notifier for notifying of an update of the RFID event management policy, and when the policy determiner is notified of the update of the RFID event management policy by the policy event notifier, the policy determiner may inquire an RFID event management policy corresponding to the update to the policy storage and obtain the corresponding RFID event management policy.

The policy determiner may generate an information object including the RFID event management policy and a policy determination message including the information object and transmit the policy determination message to the policy enforcer, and the policy enforcer may receive the policy determination message, extract the information object to obtain the RFID event management policy, convert the obtained RFID event management policy according to an event cycle specification (ECSpec) which is a standard of the client, and transmit the converted RFID event management policy to the client.

The policy enforcer may transmit the RFID event management policy request of the client to the policy determiner using a common open policy service (COPS) protocol, or receive the selected RFID event management policy from the policy determiner, and the policy determiner may receive the RFID event management policy request of the client from the policy enforcer, or transmit the selected RFID event management policy to the policy enforcer.

Another aspect of the present invention provides a method of enforcing an RFID event management policy including: defining and storing an RFID event management policy to be used by a client to manage an apparatus on the basis of an RFID event; receiving an RFID event management policy request from a client; analyzing a profile of the client included in the RFID event management policy request; selecting the stored RFID event management policy using the analyzed profile of the client; and transmitting the selected RFID event management policy to the client.

Defining and storing the RFID event management policy may include obtaining information for configuring the RFID event management policy and defining the RFID event management policy using the obtained information.

Selecting the stored RFID event management policy may include: noticing an update of the RFID event management policy; and selecting an RFID event management policy corresponding to the update.

Transmitting the selected RFID event management policy may include converting the selected RFID event management policy according to an ECSpec which is a standard of the client, and transmitting the converted RFID event management policy to the client.

Receiving the RFID event management policy request may include receiving the RFID event management policy using a COPS protocol.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram showing a constitution of a system for enforcing a radio frequency identification (RFID) event management policy according to an exemplary embodiment of the present invention;

FIG. 2 is a block diagram showing a constitution of a policy definer according to an exemplary embodiment of the present invention;

FIG. 3 is a flowchart illustrating a method of enforcing an RFID event management policy according to an exemplary embodiment of the present invention;

FIG. 4 is a block diagram showing in detail a constitution of a policy determiner and a policy enforcer according to an exemplary embodiment of the present invention;

FIGS. 5 and 6 are flowcharts illustrating operation of a policy determiner according to an exemplary embodiment of the present invention;

FIG. 7 is a flowchart illustrating operation of a policy enforcer according to an exemplary embodiment of the present invention;

FIG. 8 is a block diagram illustrating an example of RFID event management policy enforcement of an RFID event management policy enforcement system according to an exemplary embodiment of the present invention;

FIG. 9 shows an RFID event management policy according to an exemplary embodiment of the present invention in extensible markup language (XML) form; and

FIG. 10 shows an RFID event management policy according to an exemplary embodiment of the present invention converted according to an event cycle specification (ECSpec).

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Throughout this specification, when an element is referred to as being “connected” or “coupled” to another element, it can be directly connected or coupled to the other element or electrically connected or coupled to the other element with yet another element interposed between them.

Throughout this specification, when an element is referred to as “comprises,” “includes,” or “has” a component, it does not preclude another component but may further include the other component unless the context clearly indicates otherwise. Also, as used herein, the terms “. . . unit,” “. . . device,” “. . . module,” etc., denote a unit of processing at least one function or operation, and may be implemented as hardware, software, or combination of hardware and software.

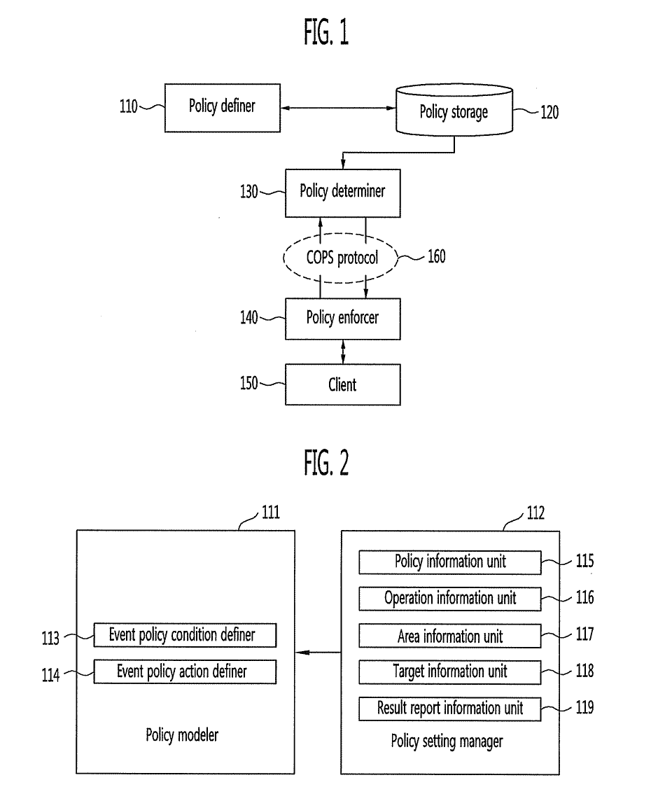

FIG. 1 is a block diagram showing a constitution of a system for enforcing a radio frequency identification (RFID) event management policy according to an exemplary embodiment of the present invention. The system for enforcing an RFID event management policy according to an exemplary embodiment of the present invention will be described below with reference to FIG. 1.

As illustrated in FIG. 1, the system for enforcing an RFID event management policy according to an exemplary embodiment of the present invention includes a policy definer 110, a policy storage 120, a policy determiner 130, and a policy enforcer 140.

The policy definer 110 defines an RFID event management policy. The RFID event management policy is referred to as a policy with which a client 150 manages an apparatus according to an RFID event at the time of managing the apparatus.

The policy storage 120 stores the RFID event management policy defined by the policy definer 110. The policy storage 120 stores the RFID event management policy so that the previously stored RFID event management policy can be reused.

The policy determiner 130 analyzes a profile of the client 150 transmitted through the policy enforcer 140 and selects the RFID event management policy stored in the policy storage 120 according to the analysis information.

The policy enforcer 140 serves to mediate a message exchange between the client 150 and the policy determiner 130. The policy enforcer 140 receives the selected RFID event management policy from the policy determiner 130, converts the RFID event management policy according to a standard executable by the client 150, and transmits the converted RFID event management policy to the client 150.

To be specific, when an RFID event management policy request message is received, the policy enforcer 140 transmits a message including the profile of the corresponding client 150 to the policy determiner 130. The policy enforcer 140 receives the RFID event management policy determined from the policy determiner 130, converts the RFID event management policy into an RFID event management standard specification of a form executable by the client 150, and transmits the RFID event management standard specification to the client 150.

The client 150 according to an exemplary embodiment of the present invention is a system that actually enforces the RFID event management policy received from the policy determiner 130, such as RFID event processing systems which comply with electronic product code (EPC) global application level events (ALE) 1.0, ALE 1.1, and other vendor standards.

The client 150 requests the RFID event management policy from the policy determiner 130 through the policy enforcer 140 and receives the RFID event management policy in response to the request. The policy enforcer 140 converts the RFID event management policy according to the RFID event management standard executable by the client 150 and transmits the RFID event management standard to the client 150.

Here, the policy enforcer 140 may be configured to transmit the RFID event management policy request message to the policy determiner 130 or receive the determined RFID event management policy or a policy determination message from the policy determiner 130 using a common open policy service (COPS) protocol 160.

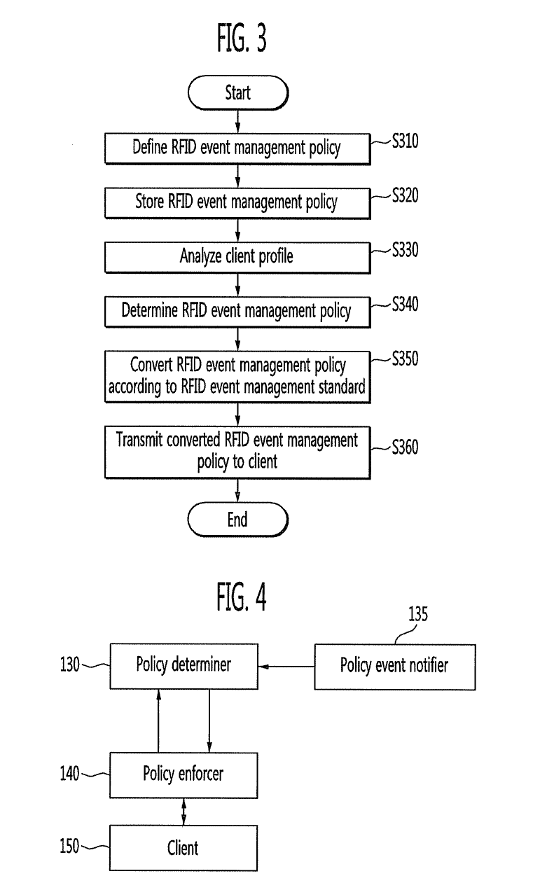

FIG. 2 is a block diagram showing a constitution of the policy definer 110 according to an exemplary embodiment of the present invention. The policy definer 110 according to an exemplary embodiment of the present invention will be described in detail with reference to FIG. 2.

As illustrated in FIG. 2, the policy definer 110 may include a policy modeler 111 and a policy setting manager 112. The policy modeler 111 includes an event policy condition definer 113 and an event policy action definer 114, and the policy setting manager 112 includes a policy information unit 115, an operation information unit 116, an area information unit 117, a target information unit 118, and a result report information unit 119.

The policy modeler 111 is configured with a function related to RFID event management policy definition. The policy modeler 111 obtains and updates information of the policy setting manager 112 and defines an event policy condition and an event policy action with reference to the information.

The policy setting manager 112 receives information for configuring an RFID event management policy from the policy storage 120 or newly generates the information. The policy modeler 111 configures an RFID event management policy using the information.

A constitution of the policy setting manager 112 will be described in detail below.

The policy information unit 115 newly generates information of the RFID event management policy, such as the name of the RFID event management policy and information according to the name, or obtains the name of the RFID event management policy and information according to the name from the policy storage 120.

The operation information unit 116 newly generates information with which the client 150 drives an apparatus according to the RFID event management policy, or obtains the information from the policy storage 120.

The area information unit 117 newly generates information related to an area of an apparatus to which the RFID event management policy is applied, or obtains the information from the policy storage 120.

The target information unit 118 newly generates information related to the apparatus to which the RFID event management policy is applied, or obtains the information from the policy storage 120.

The result report information unit 119 newly generates information related to an external terminal which is provided with a result report resulting from application of the RFID event management policy, or obtains the information from the policy storage 120.

FIG. 3 is a flowchart illustrating a method of enforcing an RFID event management policy according to an exemplary embodiment of the present invention.

An RFID event management policy enforcement system defines an RFID event management policy to be used in a client (S310). The RFID event management policy according to an exemplary embodiment of the present invention denotes a policy with which the client 150 manages an apparatus according to occurrence of an RFID event.

The RFID event management policy enforcement system stores the RFID event management policy defined as mentioned above (S320).

When an RFID event management policy request is received from a client, the RFID event management policy enforcement system analyzes the profile of the client (S330), and selects and determines the RFID event management policy stored in a policy storage according to the analysis information (S340).

The RFID event management policy enforcement system converts the determined RFID event management policy according to a standard executable by the client (S350).

In other words, when the RFID event management policy request is received, the RFID event management policy enforcement system converts the RFID event management policy corresponding to a message including the profile of the client according to the standard executable by the client.

Then, the RFID event management policy enforcement system transmits the converted RFID event management policy to the client (S360).

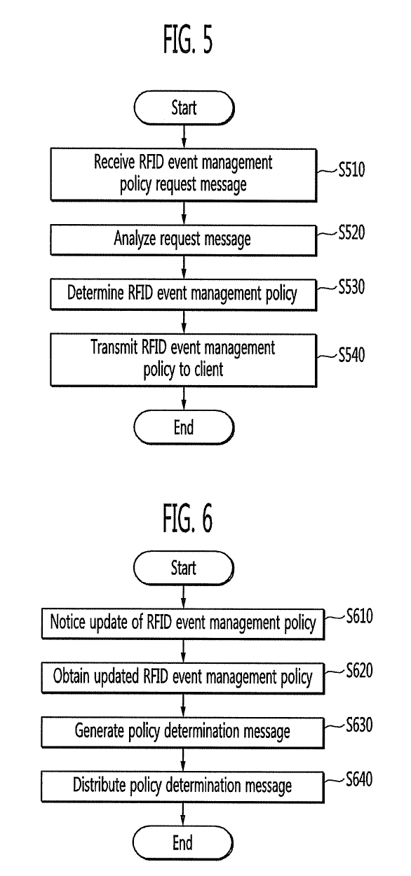

FIG. 4 is a block diagram showing in detail a constitution of the policy determiner 130 and the policy enforcer 140 according to an exemplary embodiment of the present invention, and FIGS. 5 and 6 are flowcharts illustrating operation of the policy determiner 130 according to an exemplary embodiment of the present invention.

Operation of the policy determiner 130 according to an exemplary embodiment of the present invention will be described below with reference to FIGS. 4 and 5.

The client 150 requests the policy determiner 130 to determine an RFID event management policy. To be specific, the client 150 generates and transmits a message requesting the policy determiner 130 to determine RFID event management policies, which can be processed by the client 150 itself, through the policy enforcer 140, and the policy determiner 130 receives the message requesting an RFID event management policy (S510). The request message includes profile information of the client 150, which is a policy determination factor of the client 150. The request message may be exchanged between the policy determiner 130 and the policy enforcer 140 using the COPS protocol 160.

The policy determiner 130 analyzes the request message received through the policy enforcer 140 (S520).

The policy determiner 130 determines an RFID event management policy appropriate for the client 150 using the profile information of the client 150 included in the analyzed request message (S530).

The policy determiner 130 converts the determined RFID event management policy according to a standard executable by the client 150 and transmits the converted RFID event management policy to the client 150 through the policy enforcer 140 (S540).

Operation of the policy determiner 130 performed according to an exemplary embodiment of the present invention when an event related to an update of an RFID event management policy occurs will be described below with reference to FIGS. 4 and 6.

An RFID event management policy enforcement system according to an exemplary embodiment of the present invention may further include a policy event notifier 135 as shown in FIG. 4. The policy event notifier 135 notifies an update of an RFID event management policy.

When the policy determiner 130 is notified of the update of the specific RFID event management policy by the policy event notifier 135 (S610), the policy determiner 130 inquires of the policy storage 120 about the RFID event management policy corresponding to the update and obtains the corresponding RFID event management policy (S620).

The policy determiner 130 generates a policy determination message including the RFID event management policy (S630), searches for a list of the clients 150 having a right to read the obtained policy from a reader list of the policy storage 120, and distributes the policy determination message to the clients 150 included in the reader list (S640).

To be specific, the policy determiner 130 analyzes the profile of the client 150, generates an information object including the RFID event management policy, and generates the policy determination message including the information object. The policy determiner 130 transmits and distributes the policy determination message to the clients 150 that have the reading right and are included in the reader list through the policy enforcer 140.

At this time, the policy enforcer 140 may convert the policy determination message according to the standard appropriate for the client 150 and transmit the converted policy determination message to the client 150.

FIG. 7 is a flowchart illustrating operation of the policy enforcer 140 according to an exemplary embodiment of the present invention. Operation of the policy enforcer 140 according to an exemplary embodiment of the present invention will be described below with reference to FIGS. 4 and 7.

The policy enforcer 140 receives a policy determination message from the policy determiner 130 (S710).

The policy enforcer 140 extracts an RFID event management policy from the policy determination message (S720).

Subsequently, the policy enforcer 140 converts the extracted RFID event management policy according to an event cycle specification (ECSpec) which is an RFID event management standard supported by the client 150 (S730).

Here, the policy enforcer 140 extracts the information object from the received policy determination message to obtain the RFID event management policy, and converts as many RFID event management policies as the number of the clients 150 according to the ECSpec.

The policy enforcer 140 transmits the converted RFID event management policies to the clients 150 respectively (S740).

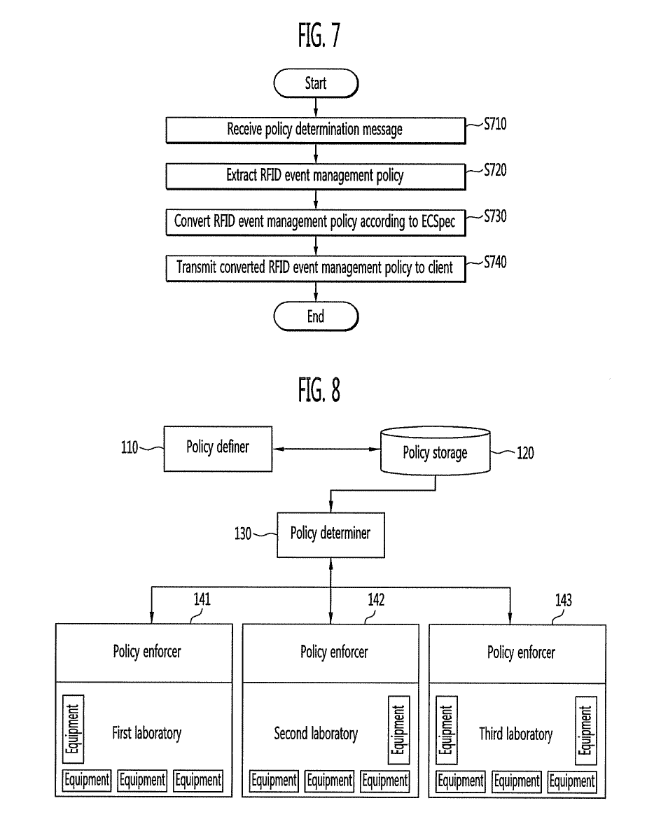

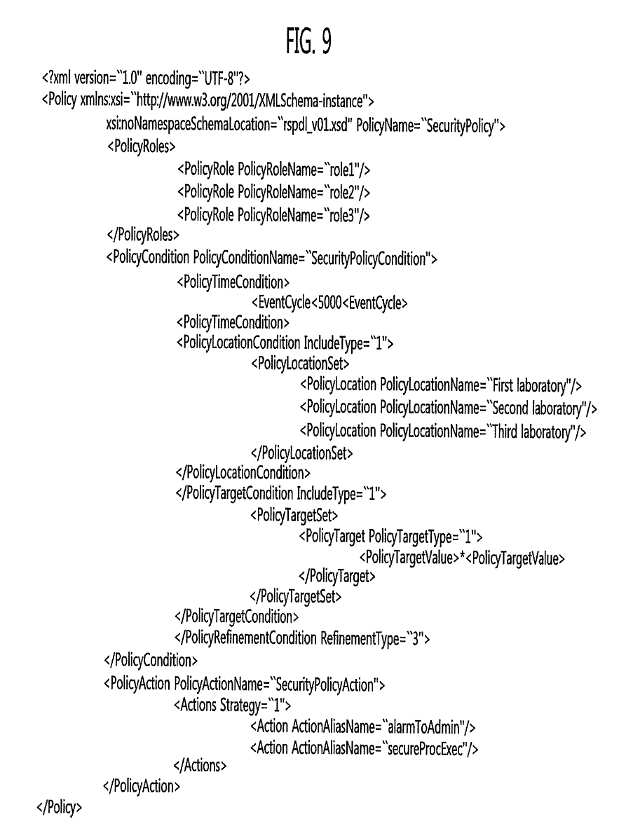

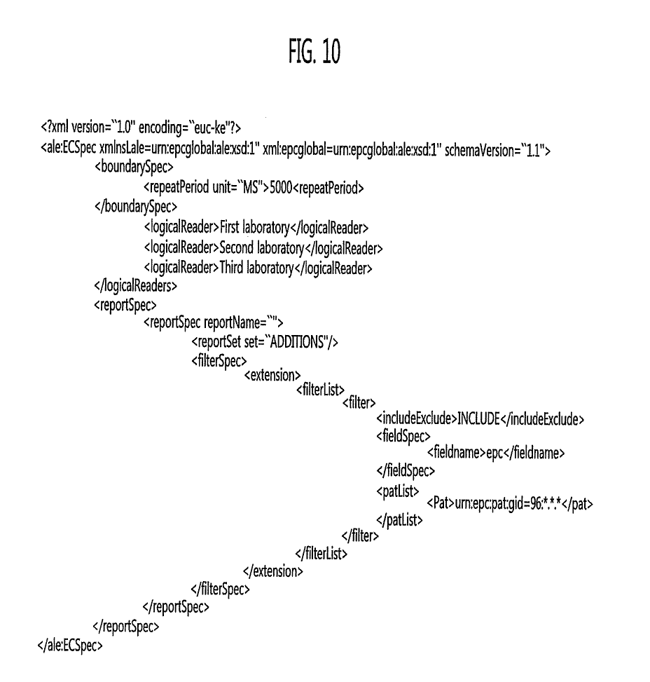

FIG. 8 is a block diagram illustrating an example of RFID event management policy enforcement of an RFID event management policy enforcement system according to an exemplary embodiment of the present invention. FIG. 9 shows an RFID event management policy according to an exemplary embodiment of the present invention in extensible markup language (XML) form. FIG. 10 shows an RFID event management policy according to an exemplary embodiment of the present invention converted according to the ECSpec.

As an example in which an RFID event management policy enforcement system according to an exemplary embodiment of the present invention enforces a laboratory equipment management policy for equipment security of each laboratory, a case where an RFID event management policy has an enforcement policy name called “a laboratory equipment management policy” and first to third laboratories have a role name called “laboratory equipment management” will be described below with reference to FIG. 8.

The policy definer 110 may define a laboratory equipment management policy, and the policy storage 120 may store the defined laboratory equipment management policy. The defined laboratory equipment policy, that is, an RFID event management policy may be defined in XML form by the policy definer 110 as illustrated in FIG. 9, and stored in the policy storage 120.

In the RFID event management policy enforcement system according to an exemplary embodiment of the present invention, the policy definer 110 may set “laboratory equipment management” as a role of the RFID event management policy, set “first to third laboratories” as areas, set designated “equipment” as a target, and set “equipment management monitoring software” as an external terminal to which the result of application of the RFID event management policy is reported.

Using the above setting, “determining whether or not the designated equipment of the first to third laboratories was stolen per 5000 ms” may be defined as an “event policy condition” of the “laboratory equipment management policy,” and “operating a security guard service for stolen equipment” may be defined as “event policy action”.

The policy determiner 130 receives a policy determination request message from each of the first to third laboratories through the policy enforcers 141, 142, and 143 of the first to third laboratories, searches for an appropriate policy from the policy storage 120 to generates a policy determination message, and converts the policy determination message according to the ECSpec and transmits the converted policy determination message to the policy enforcers 141, 142, and 143 of the first to third laboratories.

Here, the policy determination message may be converted according to the ECSpec as shown in FIG. 10, and the ECSpec is the event management standard of the form understandable by a client complying with the ALE1.1 standard of EPCglobal.

As described above, a system and method for enforcing an RFID event management policy according to an exemplary embodiment of the present invention facilitate event management based on only a situational element needed for a user, unlike a definition structure that conventional RFID event management standards have.

Also, a system and method for enforcing an RFID event management policy according to an exemplary embodiment of the present invention enable a user to define an RFID event management method with an RFID event management policy language using a single interface regardless of the type of an RFID event processing system standard operating in a management domain.

Also, a system and method for enforcing an RFID event management policy according to an exemplary embodiment of the present invention support exchange of a policy whose definition has been registered in an RFID event management policy exchange protocol that supports message exchange in a policy-based RFID event framework.

Also, a system and method for enforcing an RFID event management policy according to an exemplary embodiment of the present invention enable users managing the suggested framework-based system to flexibly and uniformly distribute an RFID event management policy to systems present within a range regardless of the number of domains to be managed, the number of RFID event processing systems prepared for each domain, or event management standards that the respective systems comply with.

Also, a system and method for enforcing an RFID event management policy according to an exemplary embodiment of the present invention support an RFID service that is more convenient and intelligent and covers a wider area than a conventional RFID service, and thus it is possible to rapidly cope with various changes caused by situations, surroundings, regulations, etc. in a domain to which RFID technology is applied.

The exemplary embodiments of the present invention can also be embodied as computer-readable codes on a computer-readable recording medium. Codes and code segments constituting the programs can be easily deduced by computer programmers skilled in the art. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can also be distributed over network connected computer systems so that the computer-readable code is stored and executed in a distributed fashion.

While the invention has been shown and described with reference to certain exemplary embodiments thereof, it will be understood by those skilled in the art that various changes in form and details may be made therein without departing from the spirit and scope of the invention as defined by the appended claims.

1. A system for enforcing an RFID event management policy, comprising:
a policy definer for defining an RFID event management policy to be used by a client to manage an apparatus on the basis of an RFID event;
a policy storage for storing the RFID event management policy;
a policy determiner for selecting the RFID event management policy stored in the policy storage using a profile of the client included in an RFID event management policy request when the RFID event management policy request is received from the client; and
a policy enforcer converting the selected RFID event management policy according to a standard executable by the client.

2. The system of claim 1, wherein the policy definer includes:
a policy setting manager for receiving information for configuring the RFID event management policy from the policy storage, or newly generating the information; and
a policy modeler for defining the RFID event management policy using the information for configuring the RFID event management policy.

3. The system of claim 2, wherein policy setting manager includes:
a policy information unit for receiving name information of the RFID event management policy from the policy storage, or newly generating the name information;
an operation information unit for receiving operation information for the client to drive the apparatus according to the RFID event management policy from the policy storage, or newly generating the operation information;
an area information unit for receiving area information, which is information on an area of the apparatus to which the client applies the RFID event management policy, from the policy storage, or newly generating the area information;
a target information unit for receiving target information, which is information on the apparatus to which the client applies the RFID event management policy, from the policy storage, or newly generating the target information; and
a result report information unit for receiving result report information, which is information on an external terminal provided with a result report resulting from application of the RFID event management policy, from the policy storage, or newly generating the result report information.

4. The system of claim 2, wherein the policy modeler includes:
an event policy condition definer for defining a condition on which the RFID event management policy works using the information for configuring the RFID event management policy; and
an event policy action definer for defining the RFID event management policy including operation of the client performed when the condition is satisfied.

5. The system of claim 1, further comprising a policy event notifier for notifying of an update of the RFID event management policy,
wherein when the policy determiner is notified of the update of the RFID event management policy by the policy event notifier, the policy determiner inquires an RFID event management policy corresponding to the update to the policy storage and obtain the corresponding RFID event management policy.

6. The system of claim 1, wherein the policy determiner generates an information object including the RFID event management policy and a policy determination message including the information object and transmits the policy determination message to the policy enforcer, and
the policy enforcer receives the policy determination message, extracts the information object to obtain the RFID event management policy, converts the obtained RFID event management policy according to an event cycle specification (ECSpec) which is a standard of the client, and transmits the converted RFID event management policy to the client.

7. The system of claim 1, wherein the policy enforcer transmits the RFID event management policy request of the client to the policy determiner using a common open policy service (COPS) protocol, or receives the selected RFID event management policy from the policy determiner, and
the policy determiner receives the RFID event management policy request of the client from the policy enforcer, or transmits the selected RFID event management policy to the policy enforcer.

8. A method of enforcing a radio frequency identification (RFID) event management policy, comprising:
defining and storing an RFID event management policy to be used by a client to manage an apparatus on the basis of an RFID event;
receiving an RFID event management policy request from a client;
analyzing a profile of the client included in the RFID event management policy request;
selecting the stored RFID event management policy using the analyzed profile of the client; and
transmitting the selected RFID event management policy to the client.

9. The method of claim 8, wherein defining and storing the RFID event management policy includes obtaining information for configuring the RFID event management policy and defining the RFID event management policy using the obtained information.

10. The method of claim 8, wherein selecting the stored RFID event management policy includes:
noticing an update of the RFID event management policy; and
selecting an RFID event management policy corresponding to the update.

11. The method of claim 8, wherein transmitting the selected RFID event management policy includes converting the selected RFID event management policy according to an event cycle specification (ECSpec) which is a standard of the client, and transmitting the converted RFID event management policy to the client.

12. The method of claim 8, wherein receiving the RFID event management policy request includes receiving the RFID event management policy using a common open policy service (COPS) protocol.
